(19) United States
(12) Patent Application Publication
(10) Pub. No.: US 2025/0329026 A1
(43) Pub. Date: Oct. 23, 2025

(54) FRAME FIELD GENERATION FOR ENHANCED IMAGE FEATURE EXTRACTION

(71) Applicant: Maxar Intelligence Inc., Westminster, CO (US)

(72) Inventor: Matthew W. Stackpole, Erie, CO (US)

(21) Appl. No.: 18/642,061

(22) Filed: Apr. 22, 2024

(51) Int. Cl. G06T 7/13; G06T 5/20; G06V 10/44; G06V 20/10

(52) U.S. Cl. CPC G06T 7/13; G06T 5/20; G06V 10/44; G06V 20/176; G06T 2207/20044

(57) ABSTRACT

Methods, systems and computer program products are provided for generating shape representations corresponding to features in an image involving receiving image data, a 2-dimensional array of coordinates representing edges of one or more features in the image, and a list of path descriptions indicating the connectivity of points in the 2-D array to form a preliminary skeleton; interpolating orientation coefficients across the entire image using the extracted image line data and preliminary skeleton line data, thereby generating a frame field; and feeding the generated frame field to an optimization processor.

### TECHNICAL FIELD

Example embodiments described herein relate generally to the field of computer vision and, more specifically, to the generation of frame fields from image data and extracting and vectorizing features from aerial or satellite imagery.

### BACKGROUND

In the realm of remote sensing imagery, which includes aerial and satellite sensors, the vectorization of features such as road networks and building footprints is a critical task for various applications, including urban planning, navigation systems, and environmental monitoring. Buildings and roads often have irregular shapes, with features such as L-shaped extensions, curved walls, and non-orthogonal angles. Such shapes are challenging to vectorize.

Traditional vectorization techniques often rely on simple, rule-based algorithms that extract geometric features from raster images. However, these methods tend to focus on a singular aspect of the data and lack the sophistication required to handle complex imagery with high fidelity. For instance, existing vectorization methods face challenges in accurately representing the intricate topologies of road networks, especially in dealing with issues such as small loops and tangential gaps in road systems. Furthermore, building footprint extraction from high-density urban areas remains difficult due to the close proximity of buildings and the need for more precise edge delineation.

Various approaches have been developed to vectorize features in images. One such approach is rectangle approximation, which simplifies complex building footprints by approximating them with rectangular shapes. Although rectangle approximation can expedite processing and analysis and may be suitable for applications where precision is not paramount, it does not fully capture the intricate geometries of real-world features such as buildings. Consequently, it falls short in applications that demand greater detail.

Remote sensing images are typically represented as raster data, where each pixel contains information about the observed surface. In the context of feature extraction from these images, traditional methods may rely solely on pixel intensity values to delineate the boundaries of features such as buildings. However, this approach may not fully capture the complex geometric structure of buildings and could lead to inaccuracies, especially in areas with irregular shapes or complex layouts.

To address this challenge, more advanced techniques leverage additional geometric information provided by so-called frame fields. A frame field is a mathematical construct used in image processing and computer vision. It encodes local geometric properties, such as orientation, at each pixel or point in an image. By incorporating frame fields into the analysis process, algorithms gain insight into the underlying structural characteristics of buildings, such as the orientation of walls and roofs.

When converting raster data into vector data for building or road extraction, the frame field enhances the delineation process by providing guidance based on the geometric properties of the observed surfaces. Instead of relying solely on pixel intensities, the algorithm can use the local directional information encoded in the frame field to identify and delineate the boundaries of buildings more accurately.

As a result, the conversion process involves not only translating pixel values into geometric shapes but also utilizing the additional geometric information from the frame field to refine the representation of building boundaries. This integration of frame fields into the extraction process improves the fidelity of the resulting vector data, with buildings represented as more accurate and detailed vectors, capturing the nuances of their geometric structures.

To integrate frame fields into the workflow of extracting buildings and roads from remote sensing images, a frame field output can be added to a deep segmentation model. This deep neural network aligns the predicted frame field to ground truth contours and is trained accordingly. This approach uses multi-task learning to provide structural information that facilitates vectorization. While this approach improves the conversion process, it involves multiple stages of processing, each with its own computational and design challenges. The complexity of the deep neural network, including its architecture and parameters, increases when adding the frame field output for alignment. Training the network on two tasks simultaneously requires careful balancing and optimization. Additionally, high-quality ground truth data is necessary for both segmentation and frame field alignment, which can be labor-intensive and require expert knowledge, particularly for remote sensing imagery. Finally, the “black box” nature of deep learning models can result in undesirable and unexplainable output. Further, training a deep neural network on this dual task requires careful tuning of hyperparameters and potentially long training times, especially if the network is large. It also requires significant computational resources, such as GPUs, to train efficiently. These factors contribute to the overall overhead and challenges associated with this approach.

There is a need for an advanced, computationally efficient, and explainable system that addresses the limitations of existing techniques and enhances the accuracy and visual quality of both road and building footprint vectorization. Several technical challenges need to be overcome, including effectively handling segmentation inaccuracies, predicting object (e.g., road and building) characteristics such as width and surface type, and regularizing building footprints or road centerlines using global optimization techniques.

One specific challenge involves converting raster data, which consists of pixel-based representations, into vector data, which comprises points, lines, polygons, and other geometric shapes. A straightforward conversion from raster to vector can result in pixelated vectors with jagged edges, especially along diagonal lines. This is undesirable when representing building footprints or road centerlines, as they are expected to have smoother lines and more accurate geometric shapes.

Moreover, infrastructure features (e.g., roads and buildings) often exhibit specific geometric characteristics, such as 90-degree corners, straight edges, and parallel edges. The vectorization process should not only translate the raster data into vector lines and shapes but also consider these characteristics to generate a more precise and visually appealing representation of infrastructure (e.g., road and/or building) footprints.

### SUMMARY

The example embodiments described herein meet the above-identified needs by providing methods, systems and computer program products for generating shapes corresponding to features in an image. In an example embodiment, a method is described for generating shapes corresponding to features in an image. The method involves receiving image data, a 2-dimensional array of coordinates corresponding to edges of one or more features in the image data, and a list of path descriptions indicating how points in the 2-D array of coordinates are connected to form a preliminary skeleton; encoding extracted image line data from the image data as complex coefficients; interpolating the complex coefficients across the entire image in the image data using the extracted image line data and preliminary skeleton line data corresponding to the preliminary skeleton thereby generating a frame field; and feeding the frame field to an optimization processor.

In some embodiments, the method involves determining a probability loss by calculating an absolute difference between the path probability and 0.5; calculating a length loss for edge length, wherein the length loss represents a difference between the lengths of an edge and its mean; determining a frame field (FF) loss by using the frame field function to calculate the FF loss; calculating a turn loss by evaluating angles between coincident edges; calculating the distance loss of a current position of the coordinates of the 2-D array of coordinates relative to original positions of the 2-D array of coordinates; and determining one or more best-fit paths that minimize a combination of the probability loss, the length loss, the frame field loss, the turn loss, and the distance loss, thereby generating one or more optimized paths; and simplifying the one or more optimized paths by reducing the number of points or vertices.

In some embodiments, the method involves converting each preliminary skeleton into vectors, thereby creating a set of closed shapes that represent one or more building footprints or polylines that represent road centerlines. In an example embodiment, feeding the frame field to the optimization processor causes the optimization processor to minimize an Edge Energy function. In some embodiments, the method involves filtering the closed shapes based on a mean segmentation value to include a set of closed shapes that meet a predetermined threshold. The method, in some embodiments, further involves generating a set of vectors with associated confidence values. In some embodiments, the method involves converting the preliminary skeleton into one or more polygons; applying a filter to the one or more polygons based on mean segmentation value representing a level of confidence or likelihood that a given polygon represents a building; generating vectorized building footprints or road centerlines corresponding to the one or more polygons or polylines, respectively; associating confidence values, such as the mean and standard deviation of the segmentation values, with each vector; and storing in a data store vectors with the corresponding confidence values.

A system for generating shapes corresponding to features in an image is also described. The system includes: a memory storage and a processing unit coupled to the memory storage, wherein the processing unit is operative to: receive image data, a 2-dimensional array of coordinates corresponding to edges of one or more features in the image data (607), and a list of path descriptions indicating how points in the 2-D array of coordinates are connected to form a preliminary skeleton; encode extracted image line data from the image data as complex coefficients; interpolate the complex coefficients across the entire image in the image data using the extracted image line data and preliminary skeleton line data corresponding to the preliminary skeleton thereby generating a frame field; and feed the frame field to an optimization processor.

In some embodiments, the processing unit is further operative to: determine a probability loss by calculating an absolute difference between the path probability and 0.5; calculate a length loss for edge length, wherein the length loss represents a difference between the lengths of an edge and its mean; determine a frame field (FF) loss by using the frame field function to calculate the FF loss; calculate a turn loss by evaluating angles between coincident edges; calculate the distance loss of a current position of the coordinates of the 2-D array of coordinates relative to original positions of the 2-D array of coordinates; and determine one or more best-fit paths that minimize a combination of the probability loss, the length loss, the frame field loss, the turn loss, and the distance loss, thereby generating one or more optimized paths; and simplify the one or more optimized paths by reducing the number of points or vertices. In some embodiments, the processing unit is further operative to: convert each preliminary skeleton into polygons, thereby creating a set of closed shapes that represent one or more building footprints or polylines that represent road centerlines. In some embodiments, the processing unit is further operative to: minimize an Edge Energy function. In some embodiments, the processing unit is further operative to: filter the closed shapes based on a mean segmentation value to include a set of closed shapes that meet a predetermined threshold.

In some embodiments, the processing unit is further operative to: generate a set of vectors with associated confidence values. In some embodiments, the processing unit is further operative to: convert the preliminary skeleton into one or more polygons; apply a filter to the one or more polygons based on mean segmentation value representing a level of confidence or likelihood that a given polygon represents a building; generate vectorized building footprints or road centerlines corresponding to the one or more polygons or polylines, respectively; associate confidence values, such as the mean and standard deviation of the segmentation values, with each vector; and store in a data store vectors with the corresponding confidence values.

A non-transitory computer-readable medium having stored thereon one or more sequences of instructions for causing one or more processors to generate shapes corresponding to features in an image. The one or more sequences of instructions cause the one or more processors to perform: receiving image data, a 2-dimensional array of coordinates corresponding to edges of one or more features in the image data, and a list of path descriptions indicating how points in the 2-D array of coordinates are connected to form a preliminary skeleton; encoding extracted image line data from the image data as complex coefficients; interpolating the complex coefficients across the entire image in the image data using the extracted image line data and preliminary skeleton line data corresponding to the preliminary skeleton thereby generating a frame field; and feeding the frame field to an optimization processor.

In some embodiments, the non-transitory computer-readable medium, further has stored thereon a sequence of instructions for causing the one or more processors to perform: determining a probability loss by calculating an absolute difference between the path probability and 0.5; calculating a length loss for edge length, wherein the length loss represents a difference between the lengths of an edge and its mean; determining a frame field (FF) loss by using the frame field function to calculate the FF loss; calculating a turn loss by evaluating angles between coincident edges; calculating the distance loss of a current position of the coordinates of the 2-D array of coordinates relative to original positions of the 2-D array of coordinates; determining one or more best-fit paths that minimize a combination of the probability loss, the length loss, the frame field loss, the turn loss, and the distance loss, thereby generating one or more optimized paths; and simplifying the one or more optimized paths by reducing the number of points or vertices. In some embodiments, the non-transitory computer-readable medium, further has stored thereon a sequence of instructions for causing the one or more processors to perform: converting each preliminary skeleton into vectors, thereby creating a set of closed shapes that represent one or more building footprints or polylines that represent road centerlines.

In some embodiments, the non-transitory computer-readable medium, further has stored thereon a sequence of instructions for causing the one or more processors to perform, wherein feeding the frame field to the optimization processor, causes the optimization processor to minimize an Edge Energy function. In some embodiments, the non-transitory computer-readable medium, further has stored thereon a sequence of instructions for causing the one or more processors to perform: filtering the closed shapes based on a mean segmentation value to include a set of closed shapes that meet a predetermined threshold. In some embodiments, the non-transitory computer-readable medium, further has stored thereon a sequence of instructions for causing the one or more processors to perform: converting the preliminary skeleton into one or more vectors; applying a filter to the one or more vectors based on mean segmentation value representing a level of confidence or likelihood that a given vector represents a feature (building or road); generating vectorized building footprints or road centerlines corresponding to the one or more polygons or polylines, respectively; associating confidence values, such as the mean and standard deviation of the segmentation values, with each vector; and storing in a data store vectors with the corresponding confidence values.

### BRIEF DESCRIPTION OF THE DRAWINGS

The features and advantages of the example embodiments of the invention presented herein will become more apparent from the detailed description set forth below when taken in conjunction with the following drawings.

FIG. 1 illustrates an example environment diagram showing a satellite or aircraft capturing an image that is processed to form a dataset of infrastructure vectors.

FIG. 2 illustrates an example system-flow diagram for forming a dataset of infrastructure vectors, according to an example embodiment.

FIG. 3 illustrates a composite visualization showing detected edges and a frame field generated by interpolating the orientations of those edges, according to an example embodiment.

FIG. 4 illustrates a composite visualization depicting an image overlaid with regularized skeletons, according to an example embodiment.

FIG. 5 illustrates a vector extraction process for extracting infrastructure vectors from aerial or satellite imagery and converting them into vectorized footprints or centerlines, according to an example embodiment.

FIG. 6 illustrates an example preliminary skeleton construction process for constructing preliminary skeletons, according to an example embodiment.

FIG. 7 depicts a frame field preparation process, according to an example embodiment.

FIG. 8 depicts an edge regularization operation for edge regularization, according to an example embodiment.

FIG. 9 depicts a vector creation process for preparing polygons or polylines, according to an example embodiment.

FIG. 10 illustrates an example block diagram of a virtual or physical computing system usable to implement aspects of the present disclosure.

### DETAILED DESCRIPTION

The example embodiments of the invention presented herein are directed to methods, systems and computer program products for automated vectorization techniques for extracting vectors from imagery, which are now described herein in terms of an example aerial or satellite imagery of features such as buildings and roads. This description is not intended to limit the application of the example embodiments presented herein. In fact, after reading the following description, it will be apparent to one skilled in the relevant art(s) how to implement the following example embodiments in alternative embodiments (e.g., involving any form of imagery and/or imagery of features other than buildings and roads).

Unless otherwise defined, all terms (including technical and scientific terms) used herein have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly so defined herein. Well known functions or constructions may not be described in detail for brevity or clarity.

Illustrative examples of the disclosure are described below. In the interest of clarity, not all features of an actual implementation are described in this specification. It will of course be appreciated that in the development of any such actual example, numerous implementation-specific decisions must be made to achieve the developers' specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

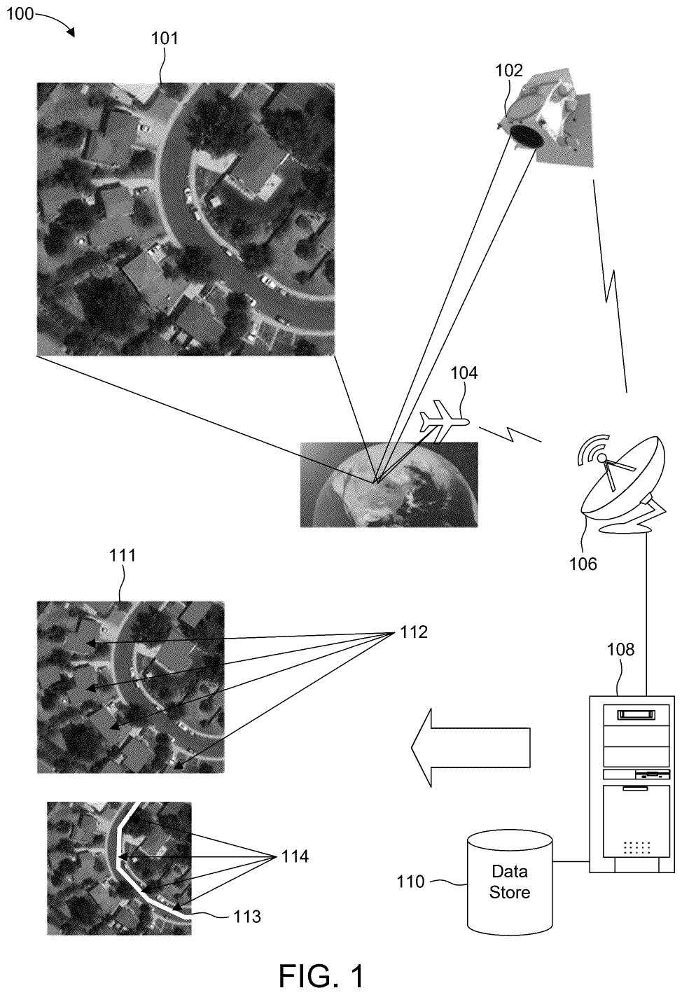

FIG. 1 illustrates an example environment diagram 100 showing a satellite or aircraft capturing an image that is processed to form a dataset of infrastructure vectors. As shown in FIG. 1, a satellite 102 or an aircraft 104 (e.g., an airplane or drone) is equipped with a high-resolution camera system. The satellite 102 captures images from space, while the aircraft 104 captures aerial images while flying over a specific portion of the Earth's surface.

The captured images are transmitted to a ground station or data processing center 106 via satellite communication or other means of data transfer. The image data is received and stored in a designated storage system 110.

An image processing computer 108 performs image processing tasks. In some embodiments, the image processing computer 108 employs a range of image processing algorithms to analyze and extract information from the satellite or aerial images. These algorithms can include image segmentation, feature extraction, object detection, classification, and other computer vision techniques.

By applying the image processing algorithms, the image processing computer 108 analyzes the image data and extracts relevant information. This information is then organized and structured to form a dataset of infrastructure vectors of buildings and/or roads.

As used herein, footprint vectors, generally refer to geometric representations that define the boundaries or outlines of buildings. They provide a concise and structured representation of the spatial extent and shape of a building structure. Referring to image 111, in some embodiments, the footprint vectors are represented as polygons, which are composed of connected lines that enclose an area occupied by the building on a two-dimensional (2D) plane. The footprint vector represented as a polygon can thus correspond to an interior of a building. The interior of a building represented by a polygon is referred to herein as a building footprint 112.

As opposed to a footprint that is 2D, a skeleton, as used herein, generally refers to one or more 1-dimensional (1D) line segments. The boundary of a footprint formed by the line segments, including interior edges, is a skeleton.

Referring still to FIG. 1, image an infrastructure vector that represents a road is referred to as a road centerline 114.

The infrastructure vector datasets (referred to sometimes simply as infrastructure datasets) can be stored in a data store 110 (e.g., data repository or database) for easy access and retrieval. The infrastructure dataset can be utilized for various applications, such as land cover mapping, urban planning, environmental monitoring, disaster management, agricultural analysis, or natural resource management. Researchers, scientists, government agencies, or businesses can leverage the infrastructure dataset for informed decision-making and advanced analysis.

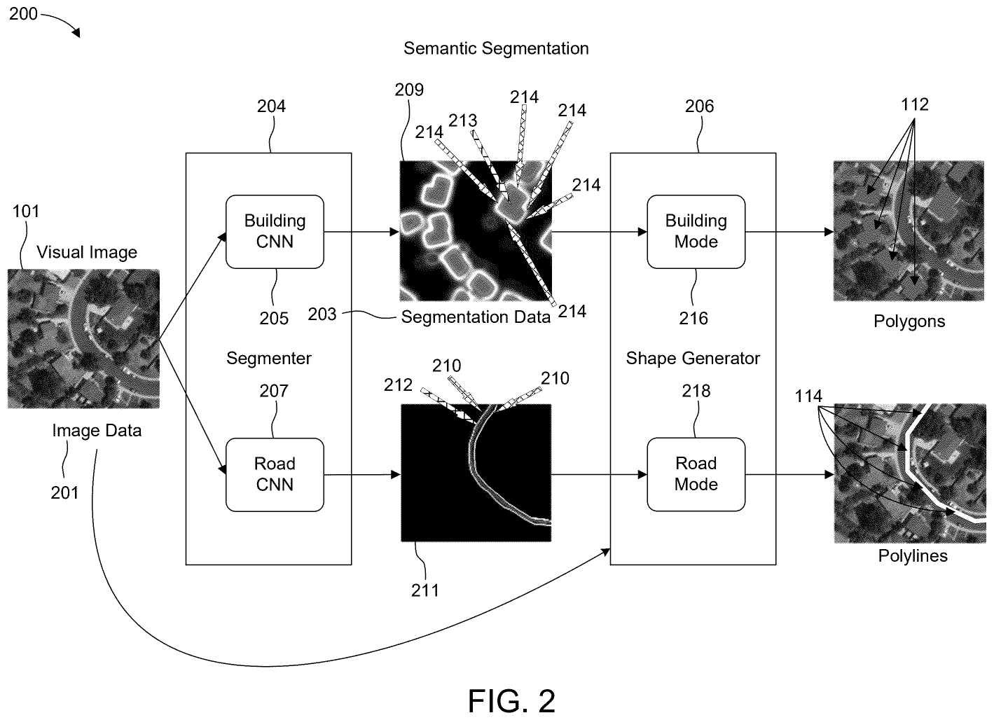

FIG. 2 illustrates an example system-flow diagram 200 for forming a dataset of infrastructure vectors (e.g., building footprints 112 and road centerlines 114), according to an example embodiment. A segmenter 204 is configured to segment the image data 201 corresponding to a visual image 101. Segmenter 204 performs segmentation on the image data 201 corresponding to the visual image 101 to extract features from the image data 201 (i.e., perform feature extraction). In the example implementation shown in FIG. 2, the image data 201 is segmented by segmenter 204 to generate semantically segmented building data 209 (also referred to as building segmentation data 209) and semantically segmented road data 211 (also referred to as road segmentation data 211). Semantically segmented building data 209 and semantically segmented road data 211 are also sometimes referred to generally as segmentation data 203.

In an example implementation, segmenter 204 is configured to segment data by dividing the visual image 101 into distinct regions or segments based on certain characteristics or criteria. In some embodiments, a segmentation algorithm is used to analyze the pixel values, colors, textures, edges, or other features of an image to identify areas that belong to the same object or share similar properties. By delineating these regions, segmentation helps to partition the image into meaningful components, making it easier to analyze or process.

Segmentation can be performed using various techniques, including thresholding, clustering, edge detection, region growing, and machine learning-based methods. Each method has its advantages and is suitable for different types of images and applications. As shown in the example embodiment of FIG. 2, segmenter 204 uses a convolutional neural network (CNN) to perform building segmentation and road segmentation. A building CNN model 205 that has been selected is trained, for example, using an annotated building training dataset and a road CNN model 207 that has been selected is trained, for example, using an annotated road training dataset. During training, segmenter 204 causes the CNN to learn to map input images to corresponding segmentation masks, which represent the pixel-wise labels indicating the presence of buildings and roads.

When dealing with buildings that are adjacent to each other or buildings that share vertices, it becomes technically challenging to treat them as separate polygons.

Adjacent buildings are those that are situated close to each other but do not necessarily share vertices along their boundaries. They may have parallel or adjacent sides without directly intersecting or sharing corner points. In other words, adjacent buildings can still be close neighbors spatially, but they are not necessarily connected or physically touching at specific points along their boundaries.

When polygons share vertices, it means that one vertex is part of both polygons' boundary definitions. When buildings share vertices, it means that two or more buildings have common corner points or vertices along their boundaries. These buildings are connected at specific points, and their boundaries intersect at these shared vertices.

Dealing with buildings that are represented as polygons, particularly where the polygons that are adjacent or share vertices, can pose technical challenges because modifications to one polygon, such as moving or adjusting its boundary, can affect the adjacent polygon. This interconnectedness complicates tasks like editing or analyzing the polygons separately. For instance, changes to shared vertices may require coordination between adjacent polygons to maintain their spatial relationships accurately. In other words, adjusting one building may necessitate tracking and adjusting the position of the neighboring building to preserve their shared corner.

To address these challenges, certain embodiments described herein focus on the exteriors of polygons rather than their interiors. Some of these exterior boundaries are shared between buildings. In the context of a segmentation raster, the bands of an image may refer to different features such as building interiors and building edges, rather than merely denoting different colors. For example, referring again to FIG. 2, the output of segmenter 204 is one or more building footprints (as depicted by building segmentation data 209) or one or more road regions (as depicted by road segmentation data 209). Each building footprint is defined by building interiors 213 and edges 214, where the combined edges 214 represent the skeleton of a building.

Referring to the road segmentation data 209, each road region 212 is defined by edges 210 that define the skeleton. Here the skeleton is a simplified representation of a road, represented in 1D as line segments or curves. Although not shown in FIG. 2, the edges 210 can also define a road surface on a two-dimensional (2D) plane.

One specific challenge involves converting raster data, which consists of pixel-based representations, into vector data, which comprises points, lines, polygons, and other geometric shapes. Notably, the conversion from a raster image to a vector image can result in pixelated vectors with jagged edges as shown by the building footprint and road region of FIG. 2. As noted above, this is undesirable when representing building footprints or road centerlines.

A frame field, as used herein, generally refers to an assignment of a vector space to each point in a plane, where the choice of basis vectors encodes a specific property. For instance, a 2-dimensional vector field may consist of two vectors at each point, denoted as {u, v}, where, for example, two walls of a building meet at a corner at that pixel are parallel to u and v, respectively. These vectors, represented as complex coefficients for mathematical convenience, effectively capture the directional aspects of features like sharp corners and straight edges in buildings. By requiring u and v to be perpendicular, the property that building walls tend to meet at right angles are encoded.

To handle ambiguities due to rotations by 90 degrees, the vectors are encoded into a complex polynomial representation. This polynomial representation helps define the frame field and is useful for numerically evaluating how well edges align to the local frame field.

Referring still the system-flow diagram of FIG. 2, a shape generator 206 is configured to generate a frame field at various points within an image (e.g., represented by image data 201). If the feature in the image data is a polygon, shape generator operates in a building mode 216 to generate polygons representing a building footprint 112. If the feature in the image data 201 is a road, shape generator 206 operates in a road mode 218 to generate polylines representing a road centerline 114.

As described above, a frame field is a mathematical construct used in image processing and computer vision. It encodes local geometric properties, such as orientation and anisotropy, at each pixel or point in an image. By incorporating frame fields into the analysis process, algorithms gain insight into the underlying structural characteristics of buildings, such as the orientation of walls and roofs.

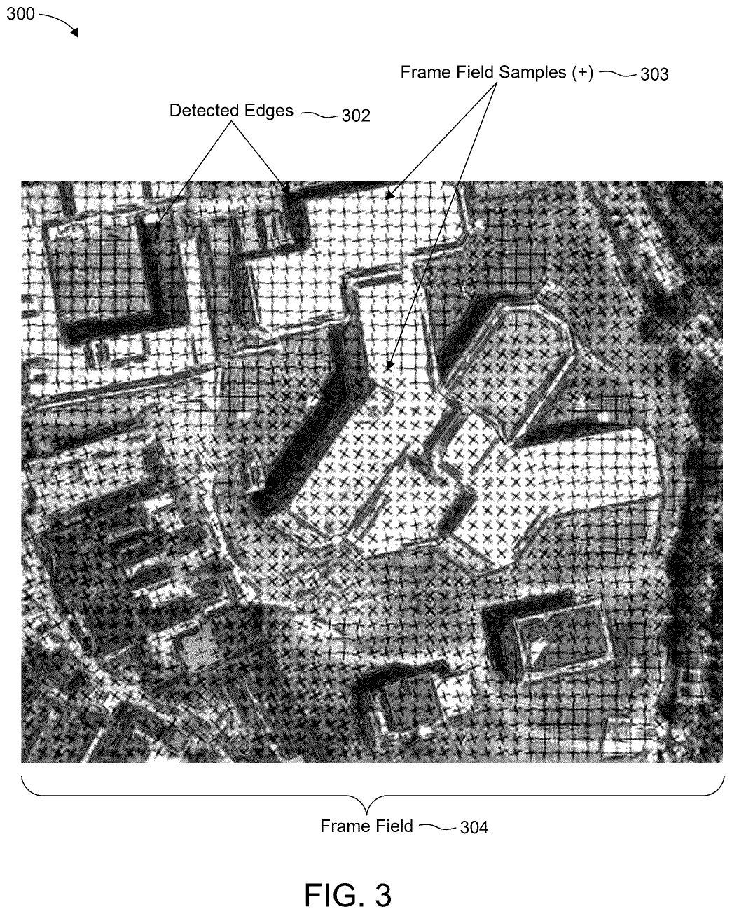

FIG. 3 illustrates a composite visualization 300 showing detected edges 302 and a frame field 304 generated from these edges 302, according to an example embodiment. Detected edges may come from a visual (RGB) image or a segmentation raster. The crosses (+) in the frame field 304 are referred to as frame field samples 303 or frame field vectors 303. These frame field samples 303 represent the orientation or direction information at specific points in the frame field 304. Each frame field sample 303 consists of a position (typically denoted by a pixel coordinate) and an associated vector that represents the local orientation or direction at that position.

Referring to FIG. 2 and FIG. 3, generally, shape generator 206 generates the frame field samples 303. In accordance with aspects of the embodiments described herein, the frame field samples 303 provide a continuous representation of the local orientations within the frame field 304, allowing for smooth variation and alignment of edges or other objects with the underlying structure of the field.

The frame field samples 303 indicate the positions where the local orientations are estimated, serving as reference points for aligning the skeletons defined by the edges 302 with a desired direction indicated by the frame field. This frame field 304 (also referred to as a local frame field) aids in aligning neighboring buildings and ensuring smooth variations. For example, such as along a circular path representing a cul de sac. In some embodiments, the edges 302 are aligned with corresponding frame field samples 303 of the local frame field 304.

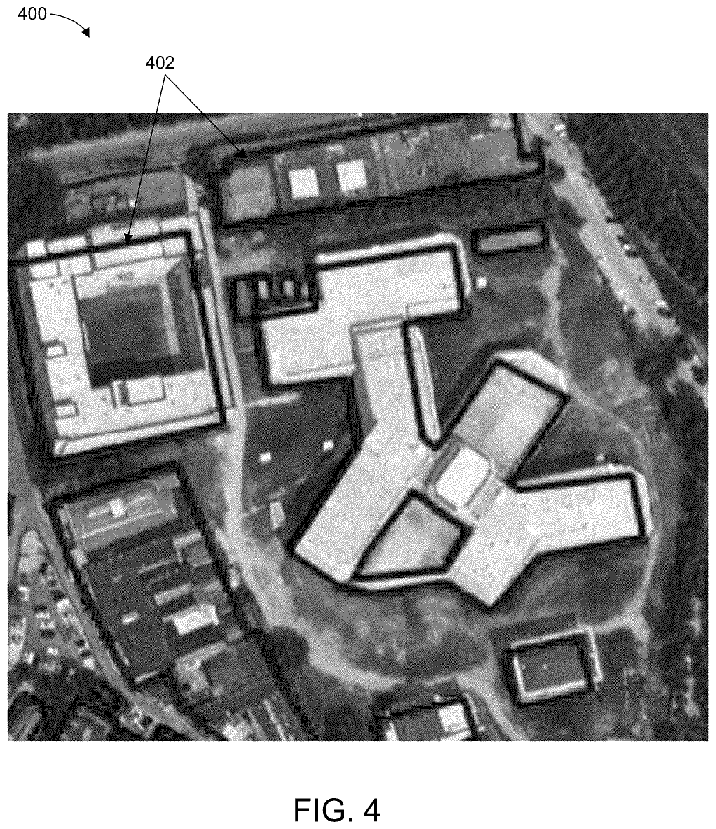

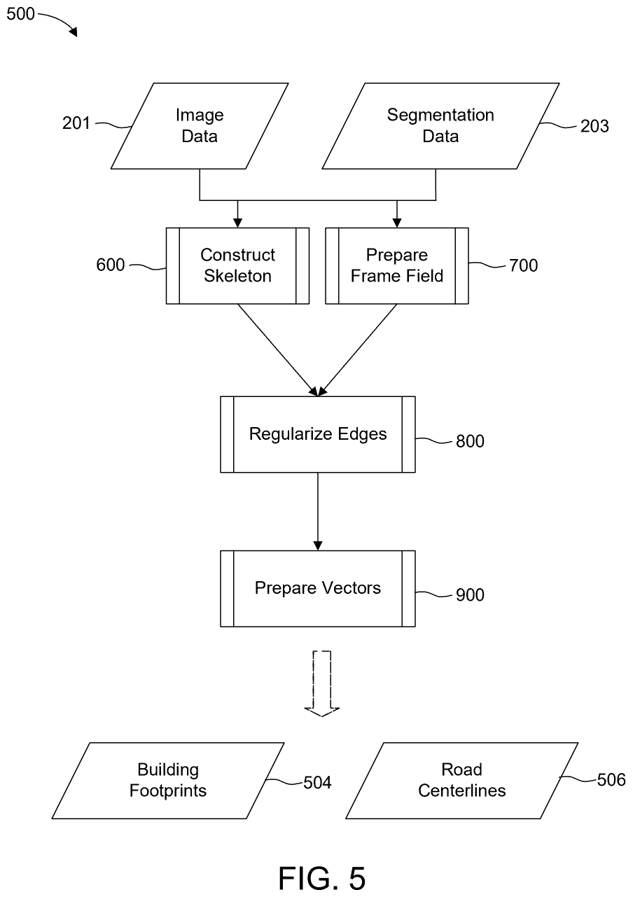

FIG. 4 illustrates another composite visualization 400 depicting an image overlaid with regularized skeletons 402, according to an example embodiment. Refined skeletons 402 are generated as described below in connection with FIGS. 5-9.

FIG. 5 illustrates a vector extraction process 500 for extracting infrastructure vectors from aerial or satellite imagery and converting them into vectorized infrastructure (e.g., road and building), according to an example embodiment.

In this example, the image data 201 includes a 2-band building segmentation. In an example implementation, both the image data and the 2-band building segmentation data are in GeoTIFF format. It should be understood that other formats can be used and still be within the scope of the embodiments described herein.

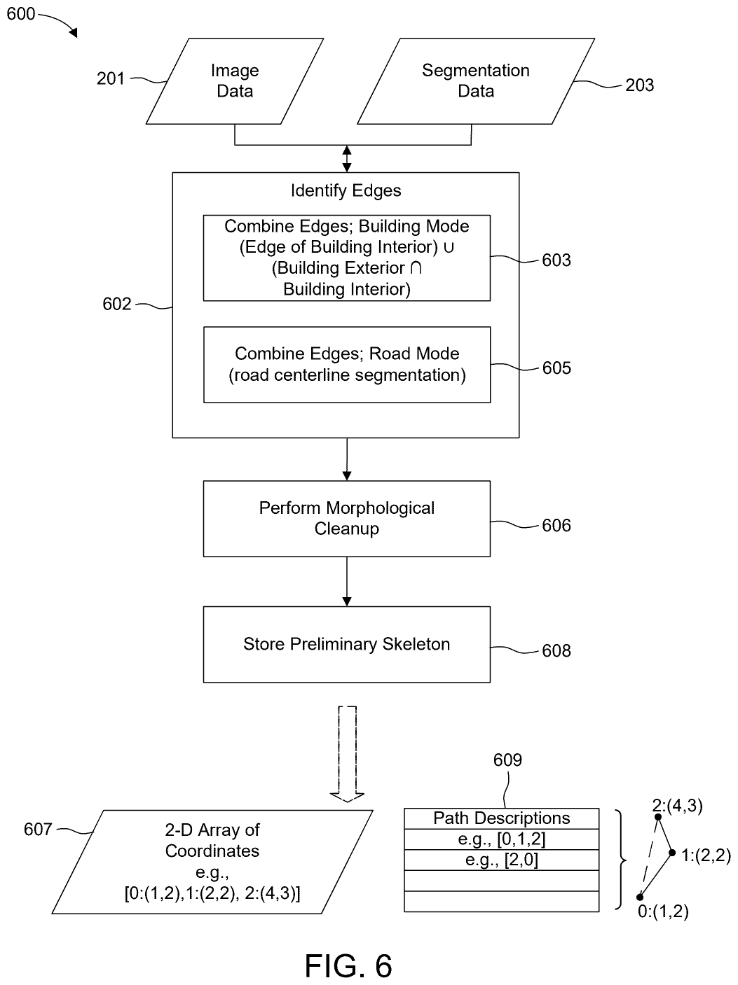

In an example embodiment, a preliminary skeleton construction process 600 is performed to construct a preliminary skeleton. An example embodiment of a preliminary skeleton construction process 600 is described below in connection with FIG. 6.

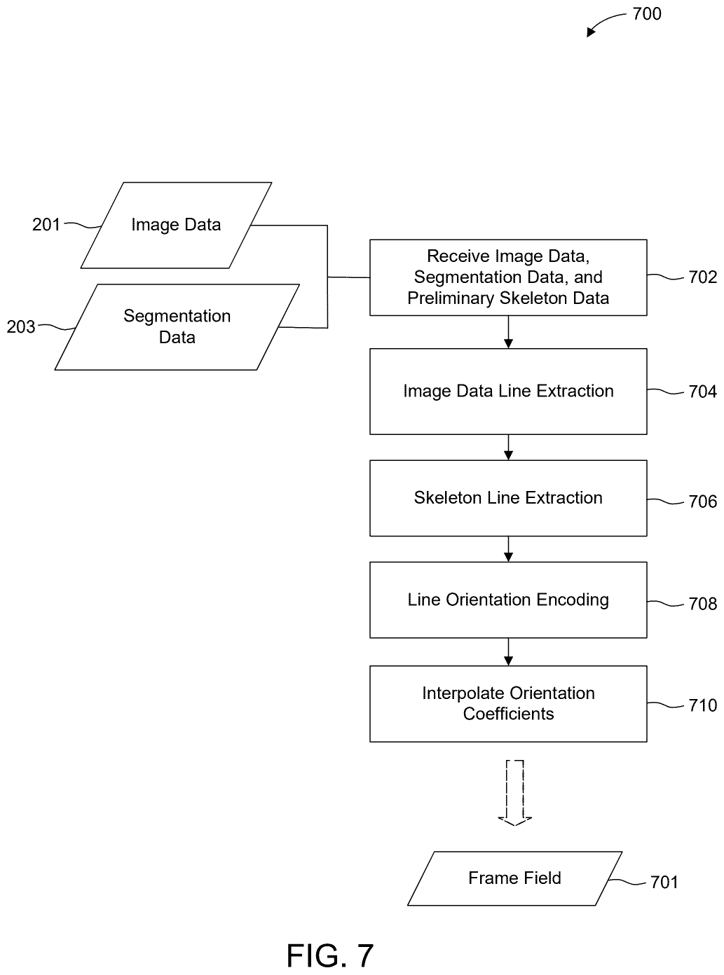

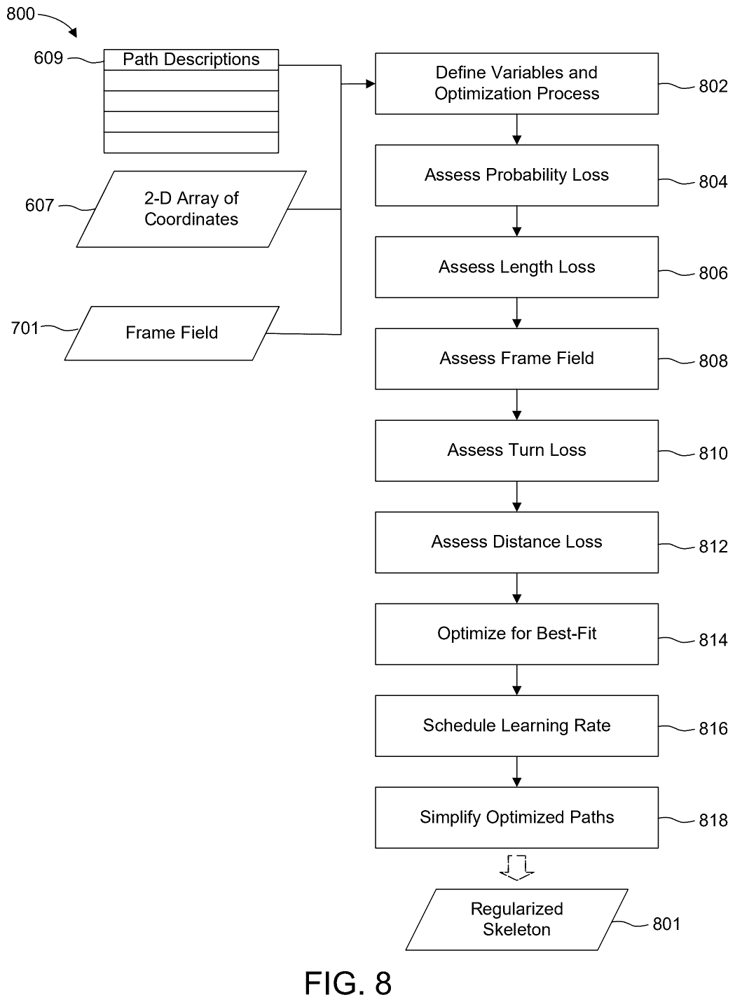

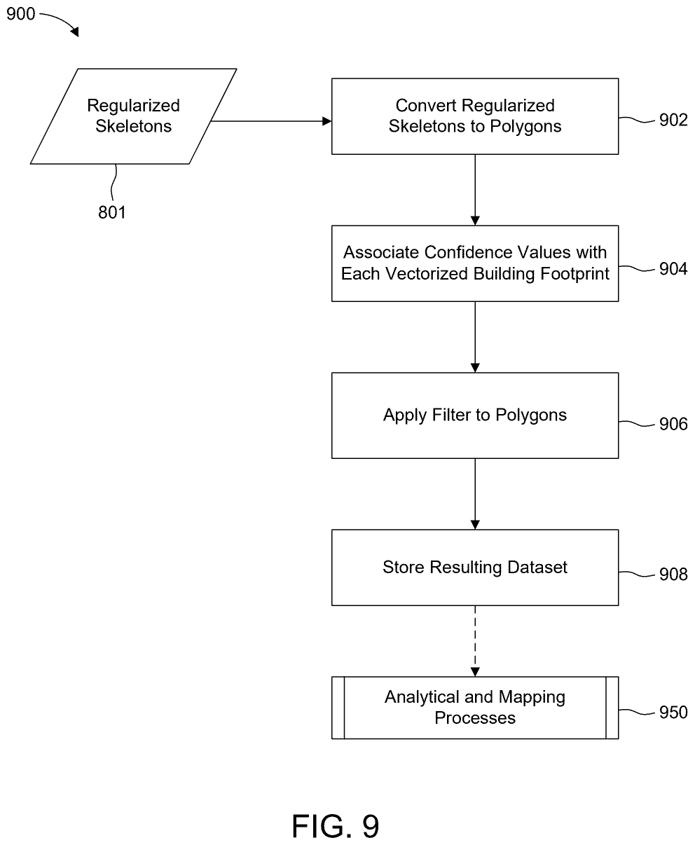

In turn, a frame field preparation process 700 performs preparing a frame field. An example embodiment of a frame field preparation process 700 is described below in connection with FIG. 7. An edge regularization process 800, in turn, regularizes edges. An example embodiment of an edge regularization process 800 is described below in connection with FIG. 8. The output of the edge regularization process 800 are one or more regularized skeletons. In turn, a vector creation process 900 performs preparing polygons (for buildings) or polylines (for roads) based on the regularized skeleton to create a set of closed shapes (e.g., polygons) that represent the building footprints or a set polylines (collection of contiguous line segments) that represents road centerlines. An example vector creation process 900 is described below in connection with FIG. 9. The output is any one or a combination of building footprints 504 or road centerlines 506.

FIG. 6 illustrates an example preliminary skeleton construction process 600 for constructing a preliminary skeleton, according to an example embodiment. In an example implementation, segmenter 204 of FIG. 2 is configured to generate the preliminary skeleton by performing the preliminary skeleton construction process 600.

As explained above, an edge of the building interior refers to a boundary or edge of a building's interior space. It represents the outline or perimeter of an area inside the building. A building exterior represents the outer boundary or perimeter of a building. It defines the shape or outline of a building structure when viewed from the outside. A building interior refers to the space enclosed by the building exterior. It represents the area inside the building structure.

In some embodiments, the shape generator 206 (FIG. 2) operates in a building mode to generate polygons representing building footprints. In an example implementation, an identification operation 602 performs identifying the edges that define the building interiors with the intersection of the building exteriors and building interiors.

The edges of a building's interior can be detected through various conventional or future developed image processing and computer vision techniques. In some embodiments, gradient-based edge detection, region-based edge detection, Hough transform, contour detection, or deep learning-based edge detection are used to detect edges.

Gradient-based edge detection involves detecting edges by analyzing changes in pixel intensity values. Techniques like the Sobel operator, Prewitt operator, or the Canny edge detector can be applied to identify areas of high gradient or rapid changes in intensity, which often correspond to edges.

Region-based edge detection involves segmenting the image into regions based on color, texture, or other features. Edges can be detected by identifying abrupt changes or discontinuities in these regions.

Hough transform, in some embodiments, can be used to detect lines and curves in an image. By applying the Hough transform, lines corresponding to the edges of building interiors can be detected.

Contour detection algorithms, such as the Marching Squares algorithm, can be used to identify continuous curves or boundaries in an image. These algorithms trace the outlines of objects, which can include the edges of building interiors.

Deep learning-based edge detection involves deep neural networks, such as the U-Net architecture or the HED (Holistically-Nested Edge Detection) model. In some embodiments, such models can be trained to detect edges in images. These models learn to identify edge patterns and can accurately detect the edges of building interiors.

In some embodiments, different specific approaches or combinations of the above-mentioned methodologies can be used for edge detection depending on the characteristics of the input data, the complexity of the building interior edges, and the desired level of accuracy in the detection process.

One option for identifying edges involves a building mode. In an example embodiment, identification operation 602 includes a combination operation 603 that performs combining the edges that define the building interiors with the intersection of the building exteriors and building interiors to generate a preliminary skeleton. Building exterior n Building interior represents the intersection between the building exterior and the building interior. It consists of the points or elements that are common to both the exterior and interior of the building. (Edge of building interior) U (Building exterior (Building interior) refers to an operation that combines the edge of the building interior with the points that are common to both the building exterior and interior. The “U” symbol denotes the union operation, which combines the elements from two sets into a single set.

In some embodiments, the shape generator 206 (FIG. 2) can also operate in a road mode to generate centerlines representing roads. In an example implementation, identification operation 602 applies segmentation data 203 to an edge identifying operation 605, where edge identifying operation 605 performs identifying edges from road segmentation data that defines road centerlines.

To perform the steps described using computational methods, a computer operating as a segmenter (e.g., segmenter 204 of FIG. 2), in an example implementation, can execute the following steps: 1. Identify and extract the building exterior and interior regions from the image data; 2. Determine the points or elements that are common to both the building exterior and interior regions. This can be achieved, for example, by comparing the coordinates or pixel values of the two regions; 3. Create a new set or data structure to store the points or elements that are common to both the building exterior and interior regions. This set represents the intersection between the two regions; 4. Identify and extract the edge of the building interior. This can be done by eroding the interior and intersecting the eroded interior with the building interior region; 5. Combine the set representing the edge of the building interior with the set representing the intersection between the building exterior and interior. This can be accomplished by performing a union operation on the two sets, which combines the elements from both sets into a single set; and 6. Store the resulting set or data structure, which now represents the combined boundary or outline of the building structure, taking into account both the interior and exterior regions.

By following these steps, a computer can effectively identify the intersection between the building exterior and interior regions and then combine it with the edge of the building interior to generate a representation of the building's boundary.

The representation of the building's boundary, in turn, undergoes a morphological cleanup operation 606. Example morphological cleanup operations include closing gaps (e.g., to fill gaps), removing holes, and simplifying the paths to create a more refined representation of the building outlines. Other morphological cleanup operations may be performed in lieu of or in addition to the foregoing morphological cleanup operations.

The output of the morphological cleanup operation is a cleaned representation of the building's boundary, referred to as a preliminary skeleton (referred to also as a “cleaned-up skeleton” or when context permits simply “skeleton”). The preliminary skeleton is then stored in a data structure as shown by store preliminary skeleton operation 608.

In an example implementation, the preliminary skeleton is stored as a two-dimensional array of coordinates 607 indicating the position of each vertex of the preliminary skeleton and a path descriptions dataset 609 (referred to simply as path descriptions 609) that describes the paths of the coordinates referencing the two-dimensional array of coordinates 607. The path descriptions 609 indicate how points in the 2-D array of coordinates are connected to form the preliminary skeleton. In an example implementation, the two-dimensional array of coordinates 607 comprises a 2×N array of coordinates, where N represents the number of vertices in the preliminary skeleton. Each point in the preliminary skeleton (e.g., where each point is a corner of a polygon) is defined by its x and y coordinates. The path descriptions 609 contains indices that define the sequence of points in the preliminary skeleton that form a continuous path. Each path represents a distinct building edge structure.

It may be the case that a point corresponding to a first building structure may be the same point of a second building structure, where the first building structure and the second building structure share vertices. In other words, there may be two polygons that point to the same coordinate. Advantageously, if that coordinate is moved, aspects of the embodiments herein does not change the fact that the two polygons point to the same coordinate. A coordinate may thus have a relationship to multiple polygons and changing that coordinate will affect the skeleton of both polygons.

Accordingly, this preprocessing flow takes the image data 201 and segmentation data 203 (e.g., GeoTIFF files), constructs a rough skeleton of the buildings, cleans up the skeleton using morphological operations, and stores the resulting skeleton as a 2×N array of coordinates with a list of paths, where the resulting skeleton is referred to as a preliminary skeleton.

FIG. 7 depicts a frame field preparation process 700, according to an example embodiment. In an example implementation, shape generator 206 of FIG. 2 is configured to perform the frame field preparation process 700. In an example implementation, the frame field preparation process obtains the visual (RGB) imagery (e.g., image data 201) and segmentation data 203, as shown by receive operation 702. The segmentation data 203, also sometimes referred to as a segmentation raster, as used herein, refers to a semantic segmentation raster (as opposed to an instance segmentation raster) that is a pixelwise classification of the image data. Both semantic and instance segmentation rasters utilize raster data structures, essentially grids where each pixel holds a value. However, the value's meaning differs significantly. Semantic segmentation rasters assign each pixel a class label (e.g., integer value 1 for car, 2 for person). This creates a thematic map where every pixel belongs to a single pre-defined category. Instance segmentation rasters, on the other hand, delve deeper. They often employ multiple channels within the raster. One channel might function similarly to semantic segmentation, assigning a class label. However, additional channels encode instance information. This could involve assigning each unique object instance within a class a unique identifier (another integer value) in a separate channel, effectively creating a detailed mask for each individual object.

Generating semantic segmentation rasters is generally less computationally intensive than instance segmentation rasters for several reasons. Semantic segmentation models only need to classify each pixel into a pre-defined category. This classification typically involves analyzing the local features of the pixel and its neighbors. Instance segmentation, however, requires not only classifying the pixel but also identifying the specific instance it belongs to. This often involves more complex network architectures and reasoning about relationships between different parts of the image. In addition, semantic segmentation rasters typically use a single channel to store the class label for each pixel. Instance segmentation rasters, on the other hand, might require multiple channels. One channel for class labels and additional channels to encode instance information (e.g., unique identifiers). Processing and storing these extra channels add to the computational burden.

In turn, an image data line extraction operation 704 performs extracting lines from the image data (e.g., visual or segmentation imagery). In an example implementation, the line extraction operation 704 is performed by applying line detection algorithms, such as the Hough transform or edge detection methods, to identify lines present in the image data (e.g., the visual imagery). These lines represent visual features or structures.

A skeleton line extraction operation 706 performs extracting lines from the preliminary skeleton data. The skeleton line extraction operation 706 performs identifying lines from the preliminary skeleton representation. These lines represent the structure or shape of the object or region. In some embodiments, the same process that is used for visual images works for the segmentation raster, since they are both images.

In turn, a line orientation encoding operation 708 performs encoding line orientations as complex coefficients. In an example implementation, the orientation of each line extracted from both the visual imagery (e.g., image data 201) and the preliminary skeleton data (e.g., the 2-D array of coordinates 607 and the path descriptions 609) is encoded as complex numbers. These complex numbers mathematically represent the direction or orientation of the lines. The real part of a complex number represents the cosine of an angle, while the imaginary part represents a sine of the angle. This representation allows for efficient storage and manipulation of line orientations, facilitating further analysis or processing tasks that rely on directional information. The frame field encodes these orientations as a polynomial whose roots are those complex numbers, along with rotations of 90 degrees.

An interpolation operation 710 performs interpolating orientation coefficients across the entire image in the image data 201. To create a continuous frame field, interpolation operation 710, in an example implementation, interpolates the orientation coefficients across the entire image corresponding to the image data 201. In this step, the orientation coefficients are assigned to every pixel or grid point in the image represented by the image data 201.

A grid, as used herein, generally refers to a regular arrangement of uniformly spaced horizontal and vertical lines that intersect to form a network of squares, rectangles, or other geometric shapes. A grid divides a space or surface into a series of cells or grid points, creating a systematic and structured framework for organizing, analyzing data, and representing data. It divides a space or surface into regular cells or points, enabling efficient processing, analysis, and visualization of data.

In an example implementation, a so-called regular grid is established using an interpolation method such as Inverse Distance Weighting (IDW). IDW establishes the regular grid for the frame field and assigns weights to neighboring grid points based on their distances from a target point. These weights are then used to interpolate the orientation coefficients for the target point.

A “regular grid,” refers to a grid structure that has a consistent and uniform spacing between its grid points or cells. Each grid point in a regular grid is equidistant from its neighbors, forming a predictable and evenly spaced arrangement. More technically, a “regular grid” also is a tessellation of n-dimensional Euclidean space by congruent parallelotopes (e.g., bricks).

In some embodiments, a regular grid is used in the frame field preparation operations described herein. The significance of using a regular grid in the frame field preparation process is that it provides a structured and systematic framework for interpolation and analysis. A regular grid allows for simpler and more efficient calculations when interpolating values or performing operations across the grid. The uniform spacing between grid points ensures consistent distances and makes computations easier to implement.

Also, with a regular grid, the frame field can be represented by a fixed number of regularly spaced points. This regular sampling facilitates subsequent analysis or processing tasks, such as vectorization or feature extraction, by providing a predictable and consistent representation of the frame field.

In addition, many interpolation methods and algorithms, such as bilinear interpolation, are designed to work with regular grid structures. Utilizing a regular grid simplifies the application of these algorithms, as they are optimized for interpolating or processing data within a regular grid framework.

By using a regular grid, the frame field can be efficiently and accurately represented, enabling subsequent operations and analysis to be performed more effectively. The regularity and uniformity of the grid structure ensure consistent and reliable results throughout the frame field representation. Interpolating the frame field to a regular grid allows it to be manipulated as a raster array, just like the visual and segmentation rasters.

The interpolation operation 710, in some embodiments also includes performing a refining operation to refine the frame field by applying bilinear interpolation. Bilinear interpolation calculates the values of intermediate points within the regular grid based on the values of the surrounding points. This interpolation process ensures a smooth and continuous frame field representation.

In an example implementation, after the interpolation and refinement steps, a frame field 701 is generated, representing the local structure and orientations of lines in the visual imagery and skeleton. The resulting frame field 701 provides additional geometric information that can guide subsequent processes, such as regularizing vector data by assisting polygonization algorithms for building extraction as shown in FIG. 5.

FIG. 8 depicts an edge regularization process 800 for edge regularization, according to an example embodiment. Edge regularization process 800 operates on the 2-D array of coordinates 607, the path descriptions 609, and frame field 701. In an example implementation, shape generator 206 of FIG. 2 is configured to perform the edge regularization process 800.

In an example implementation, edge regularization process 800 is performed by optimizing the paths that make up a skeleton as variables using a process that aims to minimize an Edge Energy function. In some embodiments, the function assesses the following: a probability loss, a length loss, a frame field (FF) loss, a turn loss, and a distance loss. In an example implementation, a probability loss is the absolute difference between the path probability and 0.5, aiming to center the paths areas along edges of building interiors. A length loss, generally, is the difference between the segment lengths and their mean for the entire edge, encouraging uniform edge length. A frame field (FF) loss, generally, is based on the frame field function, and used to align the paths with the local orientations given by the frame field. A turn loss, generally, is based on the difference in angles between subsequent edges and used to encourage the paths to make turns that are close to 90 or 180 degrees, as expected in typical building shapes. A distance loss, generally, is used to prevent the paths from moving too far from their original positions, maintaining the integrity of the original skeleton.

In an example embodiment, optimization is performed using an Adam optimizer and a Cosine Annealing with Warm Restarts schedule to find the best-fit paths. Once optimized, the paths are simplified using, for example, the Douglas-Peuker algorithm to create cleaner and more general outlines.

Referring still to FIG. 8, a definition operation 802 performs defining the variables and an optimization process. The coordinates that make up the skeleton are treated as variables to be optimized. The optimization process is employed to minimize an Edge Energy function, which aims to improve the regularity and quality of the skeleton. In turn, a probability loss assessment operation 804 performs determining a probability loss by calculating an absolute difference between the path probability and 0.5. This loss metric aims to center the paths on region edges, helping to ensure that the paths are aligned with the building edge structures.

A length loss assessment operation 806 performs calculating a length loss representing the difference between the segment lengths and the edge mean segment length. This loss prevents vertices from bunching and encourages uniform edge lengths, promoting a more regular and aesthetically pleasing representation of the skeleton.

A frame field (FF) assessment operation 808 performs determining the frame field (FF) loss by using a frame field complex polynomial f(z)=z\hat{ }4−u\hat{ }4 to calculate the FF loss. Here z represents the unit length complex representation of an edge and u\hat{ }4 represents the frame field as output (e.g., frame field 701 of FIG. 7). This loss metric is based on the frame field and is used to align the paths with the local orientations provided by the frame field. It helps ensure that the paths follow the expected orientations of building structures.

A frame field function is a mathematical function that assigns a frame or set of reference vectors to each point in a space or on a surface. In mathematics and computer graphics, frame fields are often used to describe geometric structures, such as surfaces or curves, and provide additional geometric information at each point, such as orientation or directionality.

In an example implementation, a frame field function can be used to perform assigning a pair of tangent vectors (tangent frame) or a pair of normal vectors (normal frame) to each pixel in the image data, representing local orientation. Using a frame field function provides a flexible and powerful way to describe and analyze geometric structures with local orientation information.

A turn loss assessment operation 810 performs calculating a turn loss. In an example implementation, angles are calculated between touching edges, and a penalty is given in the Edge Energy function to angles other than 90 or 180 degrees. Calculating the turn loss encourages the paths to make turns that are close to 90 or 180 degrees, which are typical angles expected in building shapes. This loss metric helps maintain the geometric regularity and accuracy of the skeleton.

A distance loss assessment operation 812 calculates the distance from a coordinate to its original position and serves to prevent the paths from deviating too much from their original positions. This loss metric is used to maintain the integrity and overall shape of the original skeleton. In other words, distance loss assessment operation 812 performs calculating the distance loss of a current position of the coordinates of the 2-D array of coordinates relative to original positions of the 2-D array of coordinates.

An optimization operation 814 performs determining the best-fit paths that minimize the combined losses. In an example implementation, an Adam optimizer is used to minimize the Edge Energy function by adjusting the path coordinates.

In some embodiments, a learning rate schedule operation 816 performs scheduling a learning rate during the optimization process. This schedule adjusts the learning rate, helping to converge to better solutions and avoid getting stuck in local minima. In some embodiments, learning rate schedule operation 816 performs using a Cosine Annealing Warm Restarts schedule during the optimization process to schedule the learning rate.

A simplification operation 818 performs simplifying optimized paths. Simplification operation 818 simplifies the paths to create cleaner and more generalized outlines. Path simplification, in some embodiments, involves reducing the number of points or vertices. In some embodiments, simplifying the one or more optimized paths is performed while maintaining the overall shape and essential features of the skeleton.

The edge regularization operation thus optimizes the paths of the skeleton, minimizing the Edge Energy function by considering probability, length, frame field, turn, and distance losses. The resulting optimized paths are then simplified to generate cleaner and more generalized outlines of the building structures.

FIG. 9 depicts a vector creation process 900 for preparing polygons or polylines, according to an example embodiment. In an example implementation, shape generator 206 of FIG. 2 is configured to perform the vector creation process 900.

Generally, each regularized skeleton 801 obtained from the edge regularization process 800 (FIG. 8) is converted into one or more polygons, creating a set of closed shapes that represent the building footprints. These polygons are filtered based on the mean segmentation value (confidence) to only include those that meet a predetermined threshold (e.g., 0.5). This ensures that only the most likely building shapes are retained. This filter also removes polygons that do not represent building interiors, such as courtyards.

The output of this process is a set of vectorized building footprint polygons with associated confidence values (mean and standard deviation) that are stored in a data store. This resulting dataset provides structured geospatial information about the building locations and shapes that can be used for various analytical and mapping purposes.

In an example implementation, a conversion operation 902 performs converting the regularized skeletons 801 into vectors. Converting the regularized skeleton into polygons creates closed shapes that represent the building footprints. This process involves connecting the lines or curves of the skeleton to form closed boundaries. These polygons accurately demarcate the boundaries of the buildings based on the skeleton, providing a precise representation of their shapes. In some embodiments, conversion operation 902 converts the skeleton into polygons by generating a set of vectorized building footprints. In some embodiments, conversion operation 902 converts the skeleton into polylines by generating a set of vectorized road centerlines.

A confidence association operation 904 performs associating confidence values (mean and standard deviation), such as the mean and standard deviation of the segmentation values, with each vector. These values provide additional information about the reliability or certainty of the identified shapes.

A vector filter operation 906 performs applying a filter to the one or more vetors based on mean segmentation value (also referred to as a confidence value) of the building interior or road centerline. The confidence value represents the level of confidence or likelihood that a given polygon represents a building. Only vectors that meet a certain threshold are retained, ensuring that only the most probable shapes are included.

The resulting dataset obtained from vector filter operation 906 consisting of the vectorized building footprints or road centerlines and their associated confidence values, are stored in a data store (e.g., data store 110 of FIG. 1), as indicated by storing operation 908. This structured geospatial information forms a dataset that can be utilized for various analytical and mapping purposes, such as urban planning, infrastructure development, or spatial analysis.

The polygon creation process thus converts the regularized skeleton into polygons that represent the building footprints or polylines that represent road centerlines. Filtering based on mean segmentation values ensures that only the most likely shapes are retained. The resulting dataset provides structured geospatial information about the building locations, shapes, and associated confidence values, offering valuable insights for further analysis and mapping applications, as depicted in analytical and mapping processes block 950 of FIG. 9.

### Computing System

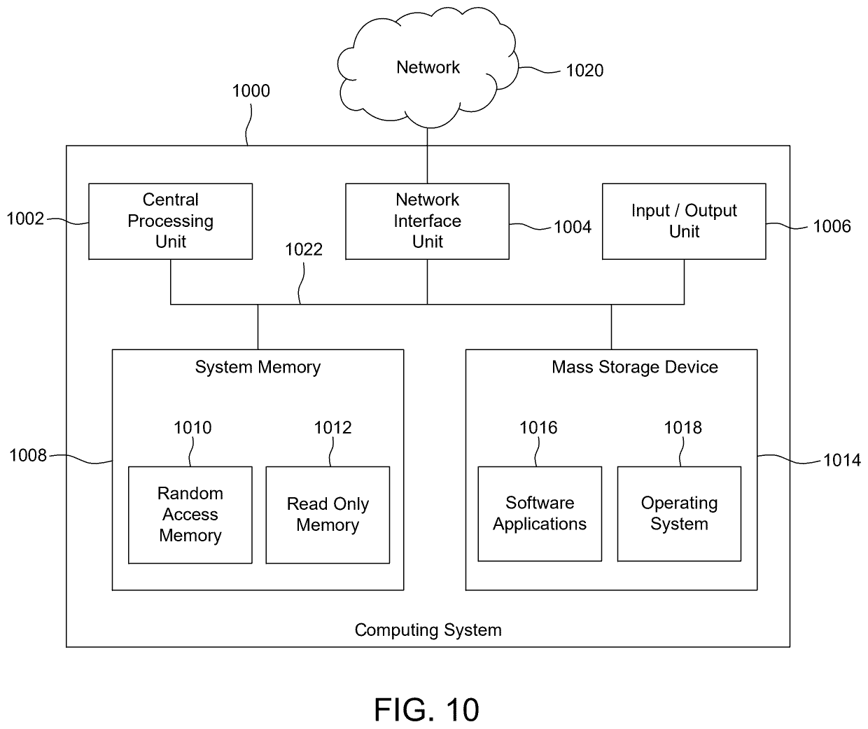

FIG. 10 illustrates an example block diagram of a virtual or physical computing system 1000. One or more aspects of the computing system 1000 can be used to implement segmenter 204 and/or shape generator 206 and the processes of FIGS. 5-9, described herein.

In the embodiment shown, the computing system 1000 includes one or more processors 1002, a system memory 1008, and a system bus 1022 that couples the system memory 1008 to the one or more processors 1002.

The one or more processors 1002 are components that execute instructions, such as instructions that obtain data, process the data, and provide output based on the processing. The one or more processors 1002 often obtain instructions and data stored in the memory 1008. The one or more processors 1002 can take any of a variety of forms, such as central processing units, graphics processing units, coprocessors, tensor processing units, artificial intelligence accelerators, microcontrollers, microprocessors, application-specific integrated circuits, field programmable gate arrays, other processors, or combinations thereof. Example providers processors 1002 include INTEL, AMD, QUALCOMM, TEXAS INSTRUMENTS, and APPLE.

The system memory 1008 includes RAM (Random Access Memory) 1010 and ROM (Read-Only Memory) 1012. The computing system 1000 further includes a mass storage device 1014. The mass storage device 1014 is able to store software instructions and data, such as those that, when executed by the one or more processors 1002 cause the one or more processors to perform operations described herein.

The mass storage device 1014 is connected to the one or more processors 1002 through a mass storage controller (not shown) connected to the system bus 1022. The mass storage device 1014 and its associated computer-readable data storage media provide non-volatile, non-transitory storage for the computing system 1000. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, DVD (Digital Versatile Discs), other optical storage media, magnetic cassettes, magnetic tape, magnetic disk storage or other magnetic storage devices, or any other medium which can be used to store the desired information and which can be accessed by the computing system 1000.

According to various embodiments described herein, the computing system 1000 operates in a networked environment using logical connections to remote network devices through the network 1020. The network 1020 is a computer network, such as an enterprise intranet and/or the Internet. The network 1020 can include a LAN, a Wide Area Network (WAN), the Internet, wireless transmission mediums, wired transmission mediums, other networks, and combinations thereof. In some embodiments, the computing system 1000 connects to the network 1020 through a network interface unit 1004 connected to the system bus 1022. It should be appreciated that the network interface unit 1004 can also be utilized to connect to other types of networks and remote computing systems.

The computing system 1000 also includes an input/output controller 1006 for receiving and processing input from a number of other devices, including a touch user interface display screen, or another type of input device. Similarly, in some embodiments, the input/output controller 1006 provides output to a touch user interface display screen or other type of output device. Examples of interfaces that the input/output controller 1006 can facilitate interaction with include components that facilitate receiving input from and providing output to something external to the computing system 1000, such as visual output components (e.g., displays or lights), audio output components (e.g., speakers), haptic output components (e.g., vibratory components), visual input components (e.g., cameras), auditory input components (e.g., microphones), haptic input components (e.g., touch or vibration sensitive components), motion input components (e.g., mice, gesture controllers, finger trackers, eye trackers, or movement sensors), buttons (e.g., keyboards or mouse buttons), position sensors (e.g., terrestrial or satellite-based position sensors such as those using the Global Positioning System), other input components, or combinations thereof (e.g., a touch sensitive display).

As mentioned briefly above, the mass storage device 1014 and the RAM 1010 of the computing system 1000 can store software instructions and data. The software instructions can include an operating system 1018 suitable for controlling the operation of the computing system 1000. In addition, the memory 1008 or mass storage device 1014 can include a basic input/output system that contains the basic routines that help to transfer information between elements within the computing system 1000, such as during startup. The mass storage device 1014 and/or the RAM 1010 also store software instructions, that when executed by the one or more processors 1002, cause one or more of the systems, devices, or components described herein to provide functionality described herein. For example, the mass storage device 1014 and/or the RAM 1010 can store software instructions that, when executed by the one or more processors 1002, cause the computing system 1000 to receive and execute managing network access control and build system processes.

The computing system 1000 can include any of a variety of other components to facilitate performance of operations described herein. Example components include one or more power units (e.g., batteries, capacitors, power harvesters, or power supplies) that provide operational power, one or more busses to provide intra-device communication, one or more cases or housings to encase one or more components, other components, or combinations thereof.

A person of skill in the art, having benefit of this disclosure, may recognize various ways for implementing technology described herein, such as by using any of a variety of programming languages (e.g., a C-family programming language, PYTHON, JAVA, RUST, HASKELL, other languages, or combinations thereof), libraries (e.g., libraries that provide functions for obtaining, processing, and presenting data), compilers, and interpreters to implement aspects described herein. Example libraries include NLTK (Natural Language Toolkit) by Team NLTK (providing natural language functionality), PYTORCH by META (providing machine learning functionality), NUMPY by the NUMPY Developers (providing mathematical functions), and BOOST by the Boost Community (providing various data structures and functions) among others. Operating systems (e.g., WINDOWS, LINUX, MACOS, IOS, and ANDROID) may provide their own libraries or application programming interfaces useful for implementing aspects described herein, including user interfaces and interacting with hardware or software components. Web applications can also be used, such as those implemented using JAVASCRIPT or another language. A person of skill in the art, with the benefit of the disclosure herein, can use programming tools to assist in the creation of software or hardware to achieve techniques described herein. Such tools can include intelligent code completion tools (e.g., INTELLISENSE) and artificial intelligence tools (e.g., GITHUB COPILOT).

One or more techniques described herein can benefit from or be implemented using a machine learning framework. A machine learning framework is a collection of software and data that implements artificial intelligence trained to provide output based on input. Examples of artificial intelligence that can be implemented in a trainable way include neural networks (including recurrent neural networks), language models (including so-called “large language models”), generative models, natural language processing models, adversarial networks, decision trees, Markov models, support vector machines, genetic algorithms, others, or combinations thereof. Machine learning frameworks or components thereof are often built or refined from existing frameworks, such as TENSORFLOW by GOOGLE, INC. or PYTORCH by the PYTORCH community. The machine learning framework can include one or more models that are the structured representation of learning and an interface that supports use of the model.

The model can take any of a variety of forms. In many examples, the model includes representations of nodes (e.g., neural network nodes, decision tree nodes, Markov model nodes, other nodes, or combinations thereof) and connections between nodes (e.g., weighted or unweighted unidirectional or bidirectional connections). In certain implementations, the model β02 can include a representation of memory (e.g., providing long short-term memory functionality). Where the set includes more than one model, the models can be linked, cooperate, or compete to provide output.

The interface can include software procedures (e.g., defined in a library) that facilitate the use of the model, such as by providing a way to interact with the model (e.g., receive and prepare input, processing the input with the model and provide output). The interface can define a vector embedding technique for creating a representation of data usable as input into the model. The software can further provide the ability to create, customize, fine tune, and train the model.

In an example implementation, interface can provide a training method that includes initializing a model, obtaining training data, providing a portion of the training data to the model to produce an actual output, comparing the expected output with the actual output, updating the model based on the result of the comparison (e.g., updating weights of the model, such as using backpropagation), continuing providing training data and updating the model until a stopping criterion has been reached, and deploying the trained model for use in production.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures shown and described above.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

Various embodiments are described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

Whenever appropriate, terms used in the singular also will include the plural and vice versa. The use of “a” herein means “one or more” unless stated otherwise or where the use of “one or more” is clearly inappropriate. The use of “or” means “and/or” unless stated otherwise. The use of “comprise,” “comprises,” “comprising,” “include,” “includes,” and “including” are interchangeable and not intended to be limiting. The term “such as” also is not intended to be limiting. For example, the term “including” shall mean “including, but not limited to.”

What is claimed is:

1. A method for generating shapes corresponding to features in an image, comprising:
receiving image data, a 2-dimensional array of coordinates corresponding to edges of one or more features in the image data, and a list of path descriptions indicating how points in the 2-D array of coordinates are connected to form a preliminary skeleton;
encoding extracted image line data from the image data as complex coefficients;
interpolating the complex coefficients across the entire image in the image data using the extracted image line data and preliminary skeleton line data corresponding to the preliminary skeleton thereby generating a frame field; and
feeding the frame field to an optimization processor.

2. The method of claim 1, further comprising:
determining a probability loss by calculating an absolute difference between the path probability and 0.5;
calculating a length loss for edge length, wherein the length loss represents a difference between the lengths of an edge and its mean;
determining a frame field (FF) loss by using the frame field function to calculate the FF loss;
calculating a turn loss by evaluating angles between coincident edges;
calculating the distance loss of a current position of the coordinates of the 2-D array of coordinates relative to original positions of the 2-D array of coordinates; and
determining one or more best-fit paths that minimize a combination of the probability loss, the length loss, the frame field loss, the turn loss, and the distance loss, thereby generating one or more optimized paths; and
simplifying the one or more optimized paths by reducing the number of points or vertices.

3. The method of claim 1, further comprising:
converting each preliminary skeleton into vectors, thereby creating a set of closed shapes that represent one or more building footprints or polylines that represent road centerlines.

4. The method of claim 1, wherein feeding the frame field to the optimization processor causes the optimization processor to minimize an Edge Energy function.

5. The method of claim 3, further comprising:
filtering the closed shapes based on a mean segmentation value to include a set of closed shapes that meet a predetermined threshold.

6. The method of claim 3, further comprising:
generating a set of vectors with associated confidence values.

7. The method of claim 3, further comprising:
converting the preliminary skeleton into one or more polygons;
applying a filter to the one or more polygons based on mean segmentation value representing a level of confidence or likelihood that a given polygon represents a building;
generating vectorized building footprints or road centerlines corresponding to the one or more polygons or polylines, respectively;
associating confidence values, such as the mean and standard deviation of the segmentation values, with each vector; and
storing in a data store vectors with the corresponding confidence values.

8. A system for generating shapes corresponding to features in an image, comprising:
a memory storage and a processing unit coupled to the memory storage, wherein the processing unit is operative to:
receive image data, a 2-dimensional array of coordinates corresponding to edges of one or more features in the image data, and a list of path descriptions indicating how points in the 2-D array of coordinates are connected to form a preliminary skeleton;
encode extracted image line data from the image data as complex coefficients;
interpolate the complex coefficients across the entire image in the image data using the extracted image line data and preliminary skeleton line data corresponding to the preliminary skeleton thereby generating a frame field; and
feed the frame field to an optimization processor.

9. The system of claim 8, the processing unit being further operative to:
determine a probability loss by calculating an absolute difference between the path probability and 0.5;
calculate a length loss for edge length, wherein the length loss represents a difference between the lengths of an edge and its mean;
determine a frame field (FF) loss by using the frame field function to calculate the FF loss;
calculate a turn loss by evaluating angles between coincident edges;
calculate the distance loss of a current position of the coordinates of the 2-D array of coordinates relative to original positions of the 2-D array of coordinates; and
determine one or more best-fit paths that minimize a combination of the probability loss, the length loss, the frame field loss, the turn loss, and the distance loss, thereby generating one or more optimized paths; and
simplify the one or more optimized paths by reducing the number of points or vertices.

10. The system of claim 8, the processing unit being further operative to:
convert each preliminary skeleton into polygons, thereby creating a set of closed shapes that represent one or more building footprints or polylines that represent road centerlines.

11. The system of claim 1, the optimization processor is configured to minimize an Edge Energy function.

12. The system of claim 10, the processing unit being further operative to:
filter the closed shapes based on a mean segmentation value to include a set of closed shapes that meet a predetermined threshold.

13. The system of claim 10, the processing unit being further operative to:
generate a set of vectors with associated confidence values.

14. The system of claim 10, the processing unit being further operative to:
convert the preliminary skeleton into one or more polygons;
apply a filter to the one or more polygons based on mean segmentation value representing a level of confidence or likelihood that a given polygon represents a building;
generate vectorized building footprints or road centerlines corresponding to the one or more polygons or polylines, respectively;
associate confidence values, such as the mean and standard deviation of the segmentation values, with each vector; and
store in a data store vectors with the corresponding confidence values.

15. A non-transitory computer-readable medium having stored thereon one or more sequences of instructions for causing one or more processors to perform:
receiving image data, a 2-dimensional array of coordinates corresponding to edges of one or more features in the image data, and a list of path descriptions indicating how points in the 2-D array of coordinates are connected to form a preliminary skeleton;
encoding extracted image line data from the image data as complex coefficients;
interpolating the complex coefficients across the entire image in the image data using the extracted image line data and preliminary skeleton line data corresponding to the preliminary skeleton thereby generating a frame field; and
feeding the frame field to an optimization processor.

16. The non-transitory computer-readable medium of claim 15, further having stored thereon a sequence of instructions for causing the one or more processors to perform:
determining a probability loss by calculating an absolute difference between the path probability and 0.5;
calculating a length loss for edge length, wherein the length loss represents a difference between the lengths of an edge and its mean;
determining a frame field (FF) loss by using the frame field function to calculate the FF loss;
calculating a turn loss by evaluating angles between coincident edges;
calculating the distance loss of a current position of the coordinates of the 2-D array of coordinates relative to original positions of the 2-D array of coordinates;
determining one or more best-fit paths that minimize a combination of the probability loss, the length loss, the frame field loss, the turn loss, and the distance loss, thereby generating one or more optimized paths; and
simplifying the one or more optimized paths by reducing the number of points or vertices.

17. The non-transitory computer-readable medium of claim 15, further having stored thereon a sequence of instructions for causing the one or more processors to perform:
converting each preliminary skeleton into vectors, thereby creating a set of closed shapes that represent one or more building footprints or polylines that represent road centerlines.

18. The non-transitory computer-readable medium of claim 15, further having stored thereon a sequence of instructions for causing the one or more processors to perform, wherein feeding the frame field to the optimization processor causes the optimization processor to minimize an Edge Energy function.

19. The non-transitory computer-readable medium of claim 17, further having stored thereon a sequence of instructions for causing the one or more processors to perform:
filtering the closed shapes based on a mean segmentation value to include a set of closed shapes that meet a predetermined threshold.

20. The non-transitory computer-readable medium of claim 17, further having stored thereon a sequence of instructions for causing the one or more processors to perform:
converting the preliminary skeleton into one or more vectors;
applying a filter to the one or more vectors based on mean segmentation value representing a level of confidence or likelihood that a given vector represents a feature (building or road);
generating vectorized building footprints or road centerlines corresponding to the one or more polygons or polylines, respectively;
associating confidence values, such as the mean and standard deviation of the segmentation values, with each vector; and
storing in a data store vectors with the corresponding confidence values.
